(19) United States
(12) Patent Application Publication
(10) Pub. No.: US 2009/0119115 A1
(43) Pub. Date: May 7, 2009

(54) Customizing A Target Using An Endpoint

(76) Inventors: Shmuel Shaffer, Palo Alto, CA (US); Ramanathan T. Jagadeesan, San Jose, CA (US); Bich T. Nguyen, Los Altos, CA (US); Gregory D. Pelton, Raleigh, NC (US); Labhesh Patel, San Francisco, CA (US)

Correspondence Address: BAKER BOTTS L.L.P., 2001 ROSS AVENUE, SUITE 600, DALLAS, TX, 75201-2980, US

(21) Appl. No.: 11/934,843

(22) Filed: Nov. 5, 2007

(51) Int. Cl. G06Q 99/00

(52) U.S. Cl. 705/1

(57) ABSTRACT

In one embodiment, customizing a target using an endpoint includes receiving customization parameters through a wireless link, where a customization parameter designating a setting for a feature of a target. The customization parameters are stored at the endpoint. A customization request comprising the customization parameters is generated. The customization request is sent to a customizer of the target to customize the target.

### TECHNICAL FIELD

The present disclosure relates generally to communication networks.

### BACKGROUND

Certain objects, such as automobiles, may have features that allow a user to access and customize the object. For example, a user may use an electronic key to automatically unlock the doors of an automobile. The user may also adjust the seats, steering wheel, and stereo receiver of the automobile. In certain automobiles, the automobile may record specific settings for specific drivers.

### BRIEF DESCRIPTION OF THE DRAWINGS

FIG. 1 illustrates an example system for accessing and customizing a target using an endpoint;

FIG. 2 illustrates an example endpoint that may be used with the system of FIG. 1;

FIG. 3 illustrates an example target management system that may be used with the system of FIG. 1; and

FIG. 4 illustrates an example method for accessing and customizing a target using an endpoint.

### DESCRIPTION OF EXAMPLE EMBODIMENTS

Overview

In one embodiment, customizing a target using an endpoint includes storing customization parameters at the endpoint, where a customization parameter designates a setting for a feature of the target. A customization request comprising the customization parameters is generated. The customization request is sent to a customizer of the target to customize the target.

Description

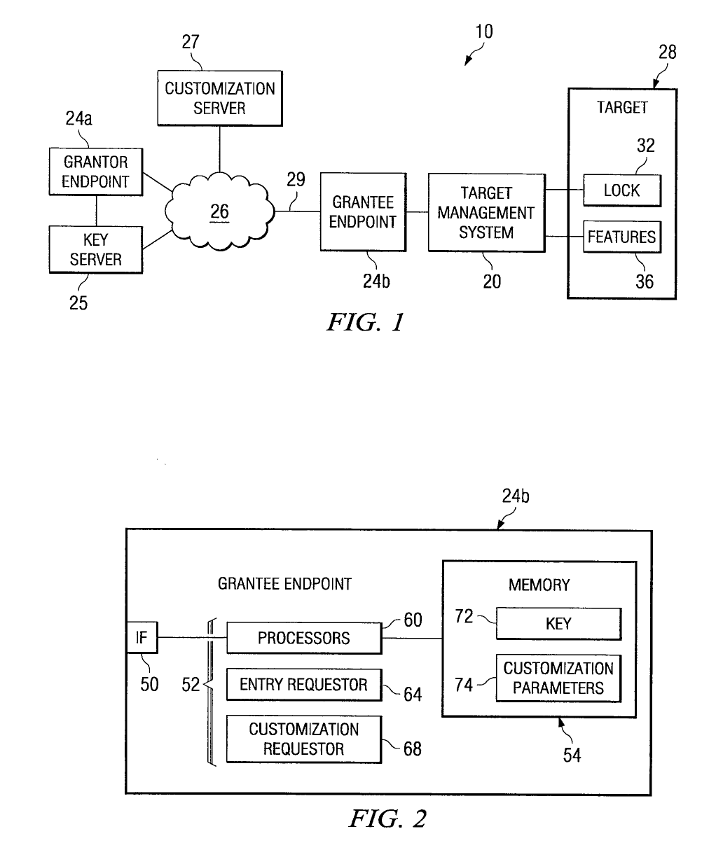

FIG. 1 illustrates one embodiment of a system 10 that includes a target 28, such as an automobile, that may be accessed and/or customized. System 10 includes endpoints 24, a key server 25, a customization server 27, a communication network 26 with a wireless link 29, a target management system 20, and a target 28 coupled as shown. Target 28 has a lock 32 and features 36.

In the embodiment, an endpoint 24a stores customization parameters for customizing target 28. The customization parameters designate settings for a feature 36 of target 28, such as a height for a seat. Endpoint 24a transmits the customization parameters to target 28 in order to customize target 28. Endpoint 24a may receive a customization update indicating that a user has adjusted a feature 36 of target 28, for example, adjusted the seat height. Endpoint 24a records the updated customization parameter.

According to the illustrated embodiment, system 10 supports communication sessions among endpoints 24. A communication session communicates information via instant messages (IMs), electronic mail (“email”) messages, voicemail messages, and/or audio and/or video signals. Information may refer to voice, data, text, audio, video, multimedia, control, signaling, and/or other information.

Endpoint 24 communicates with a communication system. Examples of endpoint 24 include a telephone such as a cellular telephone, a personal digital assistant, a computer such as a laptop, a mobile handset, or any other device operable to communicate with system 10. In the illustrated embodiment, endpoints 24 include a grantor endpoint 24a and a grantee endpoint 24b. Grantor endpoint 24a grants grantee endpoint 24b permission to access target 28, for example, unlock lock 32 of target 28. By granting the permission, grantor endpoint 24a agrees to allow grantee endpoint 24b to have a virtual key that is operable to unlock lock 32.

As an example, an automobile owner may grant a driver permission to use an automobile. The owner may use grantor endpoint 24a to send a virtual key to grantee endpoint 24b of the driver. The driver may then use the virtual key to access the car. As another example, a hotel may grant a hotel guest permission to access a room.

A virtual key may be a token (such as an encrypted file) that indicates the permission to access target 28. For example, a key may include a pass code and/or other information. The key may include attributes or a pointer to attributes that designate use of target 28, such as when, where, and/or how target 28 may be used. For example, an attribute may designate an area where an automobile may be driven.

The virtual key may be provided to grantee endpoint 24b in any suitable manner. As an example, grantor endpoint 24a may send the key to grantee endpoint 24b. As another example, grantor endpoint 24a may request that key server 25 send the key to grantee endpoint 24b. Grantee endpoint 24b may then send the key to target management system 20 in any suitable manner, such as through a wired or wireless link.

In certain cases, a breach of a restriction may occur. A breach occurs when a restriction given by an attribute restricting use of target 28 has been violated. For example, the user may drive an automobile outside of the area designated by an attribute. A designated endpoint 24 may be notified of the breach by, for example, an email, text, and/or voice message. Any suitable endpoint 24 may be the designated endpoint 24, such as the grantor endpoint 24a or another endpoint 24 designated by the grantor. Target management system 20 may notify the designated endpoint 24 directly, or may notify grantee endpoint 24b, which in turn notifies the designated endpoint 24.

The permission may be modified in response to the breach. Modifying the permission may involve adjusting the attributes to restrict the use of target 28 or revoking the permission to prohibit the use of target 28. The permission may be modified automatically in response to the breach, or may be modified after an instruction from the grantor. Target management system 20 or grantee endpoint 24b may make the modification.

Customization server 27 manages customization parameters for grantee endpoint 24b. For example, customization server 27 stores customization parameters for and/or provides customization parameters to grantee endpoint 24b. Customization parameters allow grantee endpoint 24b to customize features 36 of target 28, and may include settings for particular features 36, for example, a setting for a seat height. Customization parameters may include information to be presented to the user of target 28, for example, directions to reach a destination.

Customization server 27 obtains customization parameters (such as obtains new parameters or obtains changes to existing parameters) in any suitable manner. For example, a user may enter the parameters into customization server 27 from another endpoint, such as a computer. As another example, a user may set a feature 36 of target 28, for example, adjust a seat height. Target management system 20 may then send these parameters customization server 27 via endpoint 24b or other link.

Network 26 represents a communication network that allows endpoints 24 to communicate. A communication network may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, and/or other suitable communication links. In one embodiment, information, such as customization parameters, may be communicated to grantee endpoint 24a via a wireless link 29.

Target 28 represents any suitable object (such as a physical object) or resource that may be locked to limit access and/or may have adjustable features. Examples of an object include a vehicle (such as a boat, an airplane, a motorcycle, or an automobile), a gate, a building (such as a house or office building), a room (such as a hotel room or office), a credit card, a servicing system (such as a vending machine or an automatic teller machine), or a safe. Examples of a resource include a monetary account, such as a checking, savings, trading, or credit account.

Lock 32 locks target 28 to prevent someone from accessing, entering, and/or using target 28. Examples of locks 32 include mechanical and/or electronic (magnetic or electric strike) locks. Features 36 are features of target 28 that can be adjusted. Features 36 may include, for example, climate control, lighting, ergonomic, media, safety, informational, navigational, and/or other features. Examples of climate control features include cooling and heating systems. Examples of lighting features include the on/off and brightness of a light. Examples of ergonomic features include seat, mirror, steering wheel, and window placement. Examples of media features include audio, video, or multimedia systems. Examples of safety features include security alarms, speeding alerts, and proximity sensors. Examples of informational features include telecommunication systems and user display systems. Examples of navigational features include global positioning systems and navigational mapping systems.

Target management system manages lock 32 and features 36 of target 28. Target management system 20 may unlock lock 32 in response to receiving a virtual key. Target management system 20 may customize features 36 in accordance with customization parameters.

System 10 may utilize communication protocols and technologies to support the communication sessions. Examples of communication protocols and technologies include those set by the Institute of Electrical and Electronics Engineers, Inc. (IEEE) 802.xx standards, the International Telecommunications Union (ITU-T) standards, the European Telecommunications Standards Institute (ETSI) standards, the Internet Engineering Task Force (IETF) standards, or other standards.

A component of system 10 may include any suitable arrangement of elements, for example, an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Certain logic, such as a processor, may manage the operation of a component. Examples of a processor include one or more computers, one or more microprocessors, one or more applications, and/or other logic.

A memory stores information. A memory may comprise computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Modifications, additions, or omissions may be made to system 10 without departing from the scope of the invention. The components of system 10 may be integrated or separated. Moreover, the operations of system 10 may be performed by more, fewer, or other components. Additionally, operations of system 10 may be performed using any suitable logic. As used in this document, “each” refers to each member of a set or each member of a subset of a set.

FIG. 2 illustrates one embodiment of endpoint 24b that may be used with system 10 of FIG. 1. In the illustrated embodiment, endpoint 24b includes an interface 50, logic 52, and a memory 54 coupled as shown. Logic 52 includes one or more processors 60, an entry requester 64, and a customization requester 68. Memory 54 stores a virtual key 72 and customization parameters 74.

Entry requester 64 receives virtual key 72 from grantor endpoint 24a, and transmits key 72 to management system 20 of target 28 to unlock lock 32. In one embodiment, entry requestor 64 transmits key 72 only if certain security measures are met. For example, key 72 is transmitted only if grantee endpoint 24b is a predetermined distance (for example, less than one foot away) from a device associated with the user (for example, a watch).

In one embodiment, entry requester 64 receives a notification from target management system 20 that a breach has occurred. Entry requester 64 notifies the designated endpoint 24 of the breach, and modifies the permission to restrict or revoke the permission.

Customization requester 68 manages customization parameters 74 for customizing target 28. A customization parameter 74 indicates a setting for a feature 36 of target 28. Examples of climate control parameters include temperature settings for cooling and heating systems. Examples of lighting parameters include times when a light should be turned on or off. Examples of ergonomic parameters include settings for seat position and height. Examples of media parameters include preset radio channels. Examples of safety parameters include a maximum speed that triggers a speeding alert. Examples of informational parameters include a map to be displayed on a user display.

In one embodiment, a customization parameter 74 may be translated into a format for a particular type of target 28. A particular type may be, for example, a particular brand, make, or model of an automobile. Customization parameter 74 may be translated in any suitable manner. For example, target 28 may notify customization server 27 or customization requestor 68 of its type. Customization server 27 or customization requestor 68 may then translate customization parameters 74 in response to the notification.

Customization requestor 68 obtains customization parameters 74 (such as obtains new parameters or obtains changes to existing parameters) in any suitable manner. For example, customization server 27 may send customization parameters 74 to endpoint 24b via wireless link 29. As another example, a user may enter the parameters directly into endpoint 24b. As another example, a user may enter a customization parameter 74 from another endpoint 24, such as a computer. The other endpoint 24 may then transmit the parameters to endpoint 24b. As another example, a user may set a feature 36 of target 28, for example, adjust a seat height. Target management system 20 may then send these parameters to endpoint 24b.

Customization requestor 68 inserts the customization parameters into a customization request and transmits the customization request to a customizer of target 28 to customize target 28. The customization request may be transmitted in an access request requesting access to the target or may be transmitted in a separate message.

In one embodiment, customization requester 68 receives a customization update from target management system 20. The update indicates that a customization parameter has been updated, for example, by the user adjusting a feature 36. Customization requester 68 records the updated customization parameter.

Modifications, additions, or omissions may be made to endpoint 24b without departing from the scope of the invention. The components of endpoint 24b may be integrated or separated. Moreover, the operations of endpoint 24b may be performed by more, fewer, or other components. For example, the operations of requesters 64 and 68 may be performed by more than one component. Additionally, operations of endpoint 24b may be performed using any suitable logic.

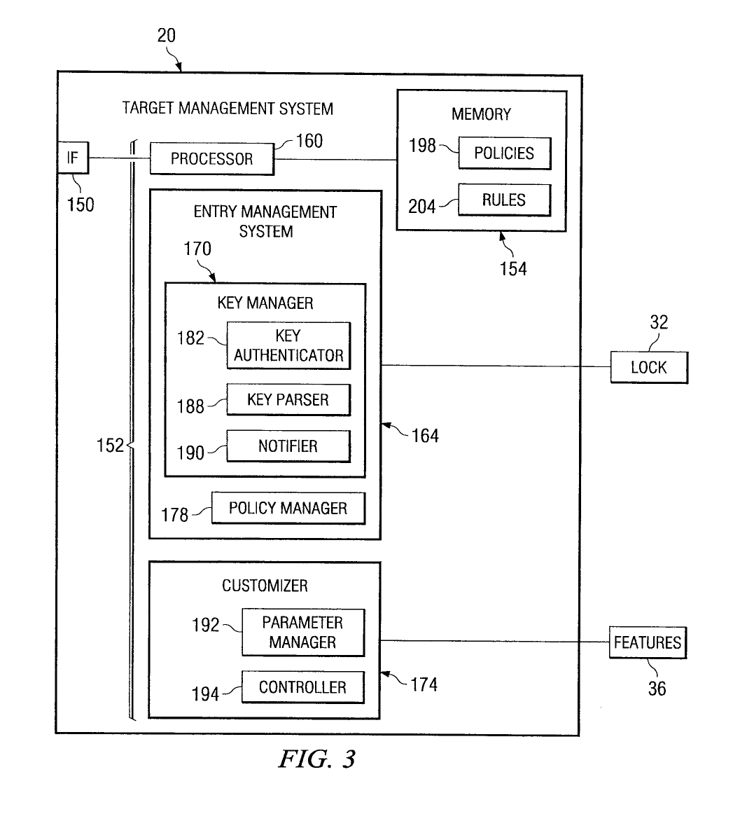

FIG. 3 illustrates one embodiment of target management system 20 that may be used with system 10 of FIG. 1. In the illustrated embodiment, target management system 20 includes an interface 150, logic 152, and a memory 154 coupled as shown. Logic 152 includes one or more processors 160, an entry management system 164, and a customizer 174. Entry management system 164 includes a key manager 170 and a policy manager 178. Key manager 170 includes a key authenticator 182, a key parser 188, and a notifier 190. Customizer 174 includes a parameter manager 192 and a feature controller 194. Memory 154 stores policies 198 and rules 204.

Entry management system 164 unlocks lock 32 in response to receiving and authenticating virtual key 72. Entry management system 164 may also detect a breach of a restriction and notify a designated endpoint 24 of the breach. Key authenticator 182 authenticates key 72 according to any suitable security measure. As an example, key authenticator 182 may require that the user of endpoint 24b enter a password along with key 72. Key parser 188 parses key 72 to extract information from key 72. Notifier 190 determines that a breach of a restriction has occurred and initiates notification of a designated endpoint 24.

Policy manager 178 manages policies 198 that include attributes designating use of the permission. An attribute may designate when, where, and/or how target 28 may or may not (“may/not”) be used. A temporal attribute designates when target 28 may/not be used, for example, target 28 may/not be used during specified hours or for longer than a specified duration. A spatial attribute designates the area in which target 28 may/not be used, for example, target 28 may only be used in a specified geographical area. A use attribute designates how target 28 may/not be used. For example, a use attribute may designate the maximum speed of a vehicle, the maximum and/or minimum climate control temperatures of a vehicle or room, or the lighting schedule of a room.

An attribute may include a combination of temporal, spatial, and/or use attributes. For example, an attribute may designate a lower maximum speed for a vehicle at night and a higher maximum speed during the day. As another example, an attribute may designate a lower maximum air conditioning temperature setting during work hours and a higher setting during other hours.

Policy manager 178 may obtain the attributes in any suitable manner. For example, policy manager 178 may extract attributes from key 72. As another example, policy manager 178 may extract a pointer from key 72, and then may use the pointer to obtain the attributes.

Customizer 174 customizes features 36 in accordance with customization parameters 74. Parameter manager 192 establishes customization parameters 74 and sends parameters 74 to feature controller 194. Parameter manager 192 also detects if a parameter 74 has been updated, for example, a user may change the seat position of a vehicle. Parameter manager 192 then records the updated parameter 74, and may send the updated parameter 74 to endpoint 24b and/or customization server 27.

Feature controller 194 adjusts features 36 in response to customization parameters 74. Feature controller 194 may adjust the features 36 in accordance with rules 204. A rule 204 specifies an adjustment of feature 36 to be made in accordance with a customization parameter 74. Feature controller 194 may also detect an adjustment of a feature 36 and may notify parameter manager 192 of the adjustment.

Modifications, additions, or omissions may be made to target management system 20 without departing from the scope of the invention. The components of target management system 20 may be integrated or separated. Moreover, the operations of target management system 20 may be performed by more, fewer, or other components. For example, the operations of key authenticator 182 and key parser 188 may be performed by one component, or the operations of customizer 174 may be performed by more than one component. Additionally, operations of target management system 20 may be performed using any suitable logic.

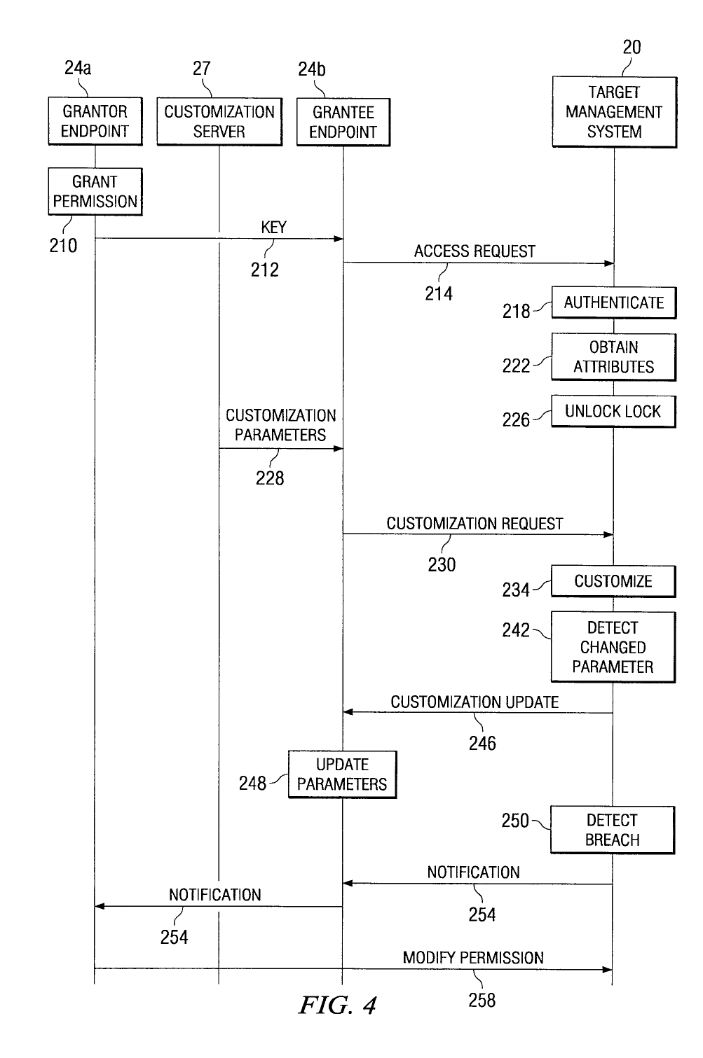

FIG. 4 illustrates one embodiment of a method for accessing and customizing target 28 using endpoint 24b. The method begins at step 210, where grantor endpoint 24a grants grantee endpoint 24b permission to access target 28. Grantor endpoint 24a allows grantee endpoint 24b to receive virtual key 72 at step 212. Grantor endpoint 24a may send key 72 to grantee endpoint 24b, or may request that key server 25 send key 72 to grantee endpoint 24b.

Grantee endpoint 24b sends an access request to target management system 20 of target 28 at step 214. The access request includes key 72. Key authenticator 182 authenticates key 72 at step 218. Policy manager 178 obtains attributes of the permission at step 222. Key 72 may include the attributes or may include a pointer that points to a policy 198 that includes the attributes. Entry management system 164 unlocks lock 32 at step 226.

Customization server 27 sends customization parameters 74 to grantee endpoint 24b at step 228. Grantee endpoint 24b sends a customization request to customizer 174 of target management system 20 at step 230. Customization request includes customization parameters 74.

Customizer 174 customizes features 36 of target 28 at step 234. Parameter manager 192 establishes customization parameters 74 from the customization request and sends them to feature controller 194, which adjusts the features 36 in accordance with parameters 74.

Target management system 20 detects that a customization parameter 74 has been changed at step 242. For example, feature controller 194 detects that a feature 36 has been adjusted and notifies parameter manager 192 of the adjustment. Parameter manager 192 determines an updated customization parameter 74 indicating the adjustment, and sends a customization update with the updated customization parameter 74 to grantee endpoint 24b at step 246. Grantee endpoint 24b updates customization parameter 74 at step 248.

Entry management system 164 detects a policy breach at step 250. Notifier 190 notifies a designated endpoint 24 of the breach at step 254. In the illustrated embodiment, the designated endpoint is grantor endpoint 24a. The designated endpoint 24 is notified directly by notifier 190 or through grantee endpoint 24b. The permission may be modified by target management system 20 or endpoint 24b at step 258. The permission may be modified to restrict or revoke the permission, and may be automatically modified or in response to an instruction from the designated endpoint 24. After the modification, the method terminates.

Modifications, additions, or omissions may be made to the method without departing from the scope of the invention. The method may include more, fewer, or other steps. Additionally, steps may be performed in any suitable order.

Certain embodiments of the invention may provide one or more technical advantages. A technical advantage of one embodiment may be that an endpoint stores customization parameters for customizing a target, such as an automobile. The customization parameters designate settings for the target, such as the seat height of the automobile. The endpoint transmits the customization parameters to the target in order to customize the target.

Another technical advantage of one embodiment may be that the endpoint receives a customization update indicating that a user has adjusted a feature of the target, for example, adjusted the seat. The endpoint records the updated customization parameter.

The present disclosure encompasses all changes, substitutions, variations, alterations, and modifications to the example embodiments described herein that a person having ordinary skill in the art would comprehend. Similarly, where appropriate, the appended claims encompass all changes, substitutions, variations, alterations, and modifications to the example embodiments described herein that a person having ordinary skill in the art would comprehend.

What is claimed is:

1. A method comprising:
receiving, at an endpoint, one or more customization parameters through a wireless link, a customization parameter designating a setting for a feature of one or more features of a target;
storing the one or more customization parameters at the endpoint;
generating a customization request comprising the one or more customization parameters; and
sending the customization request to a customizer of the target to customize the target.

2. The method of claim 1, the setting designated by a user of the target.

3. The method of claim 1, at least one feature of the one or more features comprising:
a climate control feature;
a lighting feature;
an ergonomic feature;
a media feature;
a safety feature;
an informational feature; or
a navigational system.

4. The method of claim 1, sending the customization request to the customizer of the target further comprising:
transmitting the customization request to the customizer through a wireless link.

5. The method of claim 1, sending the customization request to the customizer of the target further comprising:
transmitting the customization request to the customizer through a wired link.

6. The method of claim 1, sending the customization request to the customizer of the target further comprising:
sending the customization request in an access request requesting access to the target.

7. The method of claim 1, further comprising:
determining that a customization parameter has been updated in response to an adjusted feature; and
recording the updated customization parameter.

8. The method of claim 1, further comprising:
receiving an updated customization parameter from the target, the updated customization parameter updated in response to an adjusted feature; and
recording the updated customization parameter.

9. The method of claim 1, the target comprising:
a vehicle;
a gate;
a building;
a room;
a credit card;
a servicing system; or
a safe.

10. An apparatus comprising:
an interface operable to:
receive one or more customization parameters through a wireless link, a customization parameter designating a setting for a feature of one or more features of a target;
a memory coupled to the memory and operable to:
store the one or more customization parameters; and
a customization requester coupled to the memory and operable to:
generate a customization request comprising the one or more customization parameters; and
send the customization request to a customizer of the target to customize the target.

11. The apparatus of claim 10, the setting designated by a user of the target.

12. The apparatus of claim 10, at least one feature of the one or more features comprising:
a climate control feature;
a lighting feature;
an ergonomic feature;
a media feature;
a safety feature;
an informational feature; or
a navigational feature.

13. The apparatus of claim 10, the customization requestor further operable to send the customization request to the customizer of the target by:
transmitting the customization request to the customizer through a wireless link.

14. The apparatus of claim 10, the customization requestor further operable to send the customization request to the customizer of the target by:
transmitting the customization request to the customizer through a wired link

15. The apparatus of claim 10, the customization requestor further operable to send the customization request to the customizer of the target by:
instructing an entry requester to send the customization request in an access request requesting access to the target.

16. The apparatus of claim 10, further comprising:
an entry requester operable to send an access request requesting access to the target.

17. The apparatus of claim 10, the customization requestor further operable to:
determine that a customization parameter has been updated in response to an adjusted feature; and
record the updated customization parameter.

18. The apparatus of claim 10, the customization requestor further operable to:
receive an updated customization parameter from the target, the updated customization parameter updated in response to an adjusted feature; and
record the updated customization parameter.

19. The apparatus of claim 10, the target comprising:
a vehicle;
a gate;
a building;
a room;
a credit card;
a servicing system; or
a safe.

20. An apparatus for customizing a target from an endpoint, comprising:
means for receiving, at an endpoint, one or more customization parameters through a wireless link, a customization parameter designating a setting for a feature of one or more features of a target;
means for storing the one or more customization parameters at the endpoint;
means for generating a customization request comprising the one or more customization parameters; and
means for sending the customization request to a customizer of the target to customize the target.
